(19) United States
(12) Patent Application Publication
(10) Pub. No.: US 2006/0276230 A1
(43) Pub. Date: Dec. 7, 2006

(54) System and method for wireless audio communication with a computer

(76) Inventor: Christopher Frank McConnell, Berwyn, PA (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 11/300,042

(22) Filed: Dec. 13, 2005

Related U.S. Application Data
(63) Continuation-in-part of application No. 10/529,415, filed on Mar. 29, 2005.
(60) Provisional application No. 60/415,311, filed on Oct. 1, 2002.
(60) Provisional application No. 60/457,732, filed on Mar. 25, 2003.

(51) Int. Cl. H04B 1/38

(52) U.S. Cl. 455/563

(57) ABSTRACT

A computer-readable medium, a method and a personal computer for enabling a portable communications device to access media content. In the computer-readable medium, media content is accessed using a personal computer, and information contained in the media content is extracted. A signal representative of the extracted information is generated and transmitted to a remote communications device by way of a communication channel.

### CROSS-REFERENCE TO RELATED APPLICATIONS

This application is a continuation-in-part of U.S. application Ser. No. 10/529,415, filed Mar. 29, 2005, which is the United States national phase of International Application No. PCT/US03/31193, filed Oct. 1, 2003, which claims the benefit of U.S. Application No. 60/415,311, filed Oct. 1, 2002, and U.S. Application No. 60/457,732, filed Mar. 25, 2003. The disclosures of the above-identified documents are herein incorporated by reference in their entireties.

### FIELD OF THE INVENTION

The present invention relates to a computer interface. More particularly, the present invention relates to a system and method for interfacing with a computer by way of audio communications. Even more particularly, the present invention relates to a voice recognition system and method for receiving audio input, a module for interacting with computer applications and a module for accessing and transmitting information.

### BACKGROUND OF THE INVENTION

The public is increasingly using computers to store and access information that affects their daily lives. Personal information such as appointments, tasks and contacts, as well as data in spreadsheets, databases, word processing documents, media content and the like are all types of information that are particularly amenable to storage in a computer because of the ease of updating, organizing, and accessing such information. In addition, computers are able to remotely access time-sensitive information, Such as stock quotes, weather reports, news and so forth, on or near a real-time basis from the Internet or another network. To perform all of the tasks required of them, computers have become quite sophisticated and computationally powerful. Thus, while a user has access to his or her computer—in other words, while the user is at home or at the office—the user is able to easily access such computational power to perform a desired task.

In many situations, however, a user will require access to such information while traveling or while simply away from his or her computer. Unfortunately, the full computing power of a computer is, for the most part, immobile. For example, a desktop computer is designed to be placed at a fixed location, and is, therefore, unsuitable for mobile applications. Laptop computers are much more transportable than desktop computers, and have comparable computing power, but are costly and still fairly cumbersome. In addition, wireless Internet connectivity is expensive and still not widely available, and a cellular phone connection for such a laptop is slow by current Internet standards. In addition, having remote Internet connectivity is duplicative of the Internet connectivity a user may have at his or her home or office, with attendant duplication of costs.

Conventionally, a personal digital assistant (“PDA”) can be used to access a user's information. Such a PDA can connect intermittently with a computer through a cradle or IR beam and thereby upload or download information with the computer. Some PDAs can access the information through a wireless connection, or may double as a cellular phone. However, PDAs have numerous shortcomings. For example, PDAs are expensive, often duplicate some of the computing power that already exists in the user's computer, sometimes require a subscription to an expensive service, often require synchronization with a base station or personal computer, are difficult to use—both in terms of learning to use a PDA and in terms of a PDA's small screen and input devices requiring two-handed use—and have limited functionality as compared to a user's computer. As the amount of mobile computing power is increased, the expense and complexity of PDAs increases as well. In addition, because a conventional PDA stores the user's information on-board, a PDA carries with it the risk of data loss through theft or loss of the PDA.

As the size, cost and portability of cellular phones has improved, the use of cellular phones has become almost universal. Some conventional cellular phones have limited voice activation capability to perform simple tasks using audio commands such as calling a specified person. Similarly, some automobiles and advanced cellular phones can recognize sounds in the context of receiving simple commands. In such conventional systems, the software involved simply identifies a known command (i.e., sound) which causes the desired function, such as calling a desired person, to be performed. In other words, a conventional system matches a sound to a desired function, without determining the meaning of the word(s) spoken. Similarly, conventional software applications exist that permit an email message to be spoken to a user by way of a cellular phone. In such an application, the cellular phone simply relays a command to the software, which then plays the message.

Conventional software that is capable of recognizing speech is either server-based or primarily for a user that is co-located with the computer. For example, voice recognition systems for call centers need to be run on powerful servers due to the systems' large size and complexity. Such systems are large and complex in part because they need to be able to recognize speech from speakers having a variety of accents and speech patterns. Such systems, despite their complex nature, are still typically limited to menu-driven responses. In other words, a caller to a typical voice recognition software package must proceed through one or more layers of a menu to get to the desired functions, rather than being able to simply speak the desired request and have the system recognize the request. Conventional speech recognition software that is designed to run on a personal computer is primarily directed to dictation, and such software is further limited to being used while the user is in front of the computer and to accessing simple menu items that are determined by the software. Thus, conventional speech recognition software merely serves to act as a replacement for or a supplement to typical input devices, such as a keyboard or mouse.

Furthermore, conventional PDAs, cellular phones and laptop computers have the shortcoming that each is largely unable to perform the other's functions. Advanced wireless devices combine the functionality of PDAs and cellular phones, but are very expensive. Thus, a user either has to purchase a device capable of performing the functions of a PDA, cellular phone, and possibly even a laptop—at great expense—or the user will more likely purchase an individual cellular phone, a PDA, and/or a laptop.

Cellular telephones, however, have shortcomings when attempting to access media content, such as an audio and/or video file, streaming media, and the like. Namely, most cellular telephones are designed to process an audio signal, and are unable or ill-equipped to download and/or stream media content. The few cellular telephones that are capable of such downloading and/or streaming are typically expensive and suffer from the slow download speeds that are conventionally available over cellular networks.

Accordingly, what is needed is a portable means for communicating with a computer. More particularly, what is needed is a system and method for verbally communicating with a computer to obtain information by way of an inexpensive, portable device, such as a cellular phone. Even more particularly, what is needed is a system and method for enabling a portable communications device to access media content by way of a computer.

### SUMMARY OF THE INVENTION

In light of the foregoing limitations and drawbacks, a computer-readable medium, a method and a personal computer for enabling a portable communications device to access media content is provided herein. In the computer-readable medium, media content is accessed using a personal computer and information contained in the media content is extracted. A signal representative of the extracted information may be generated and transmitted to a remote communications device by way of a communication channel.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary embodiments of the invention; however, the invention is not limited to the specific methods and instrumentalities disclosed. In the drawings:

FIG. 1 is a diagram of an exemplary computer in which aspects of the present invention may be implemented;

FIGS. 2A-D are diagrams of exemplary computer configurations in which aspects of the present invention may be implemented;

FIG. 3 is a block diagram of an exemplary software configuration in accordance with an embodiment of the present invention;

FIGS. 4A-C are flowcharts of an exemplary method of a user-initiated transaction in accordance with an embodiment of the present invention;

FIG. 5 is a flowchart of an exemplary method of a computer-initiated transaction in accordance with an embodiment of the present invention;

FIGS. 6A-F are screenshots illustrating an exemplary interface program in accordance with an embodiment of the present invention; and

FIGS. 7A-B are screenshots illustrating an exemplary spreadsheet in accordance with an embodiment of the present invention.

### DETAILED DESCRIPTION OF ILLUSTRATIVE EMBODIMENTS

A system and method for operatively connecting a remote communications device with a computer by way of audio commands is described herein. In one embodiment of the present invention, a remote communications device such as, for example, a cellular phone, wireless transceiver, microphone, wired telephone or the like is used to transmit an audio or spoken command to a user's computer. In another embodiment, the user's computer initiates a spoken announcement or the like to the user by way of the same remote communications device. An interface program running on the user's computer operatively interconnects, for example, speech recognition software to recognize the user's spoken utterance, text-to-speech software to communicate with the user, appointment and/or email software, spreadsheets, databases, media content, the Internet or other network and/or the like. The interface program also can interface with computer I/O ports to communicate with external electronic devices such as actuators, sensors, fax machines, telephone devices, stereos, appliances, servers and the like. It will be appreciated that in such a manner an embodiment of the present invention enables a user to use a portable communications device to communicate with his or her computer from any location.

For example, in one embodiment, a user may operate a cellular phone to call his or her computer. Upon establishing communications, the user may request any type of information the software component is configured to access. In another embodiment, the computer may contact the user by way of such cellular phone to, for example, notify the user of an appointment or the like. It will also be appreciated that the cellular phone need not perform any voice recognition or contain any of the user information that the user wishes to access. In fact, a conventional, “off-the-shelf” cellular phone or the like may be used with a computer running software according to one embodiment of the present invention. As a result, an embodiment of the present invention enables a user to use the extensive computing power of his or her computer from any location, and by using any of a wide variety of communications devices.

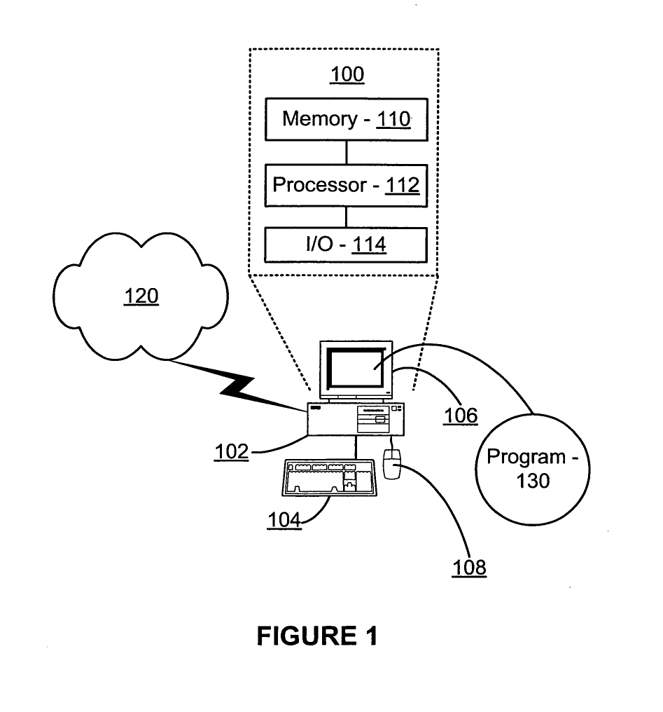

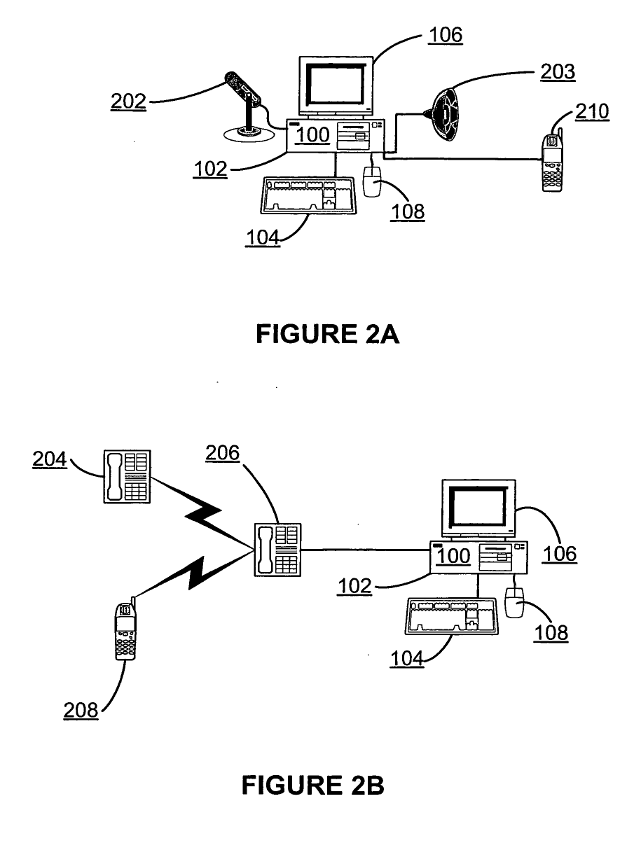

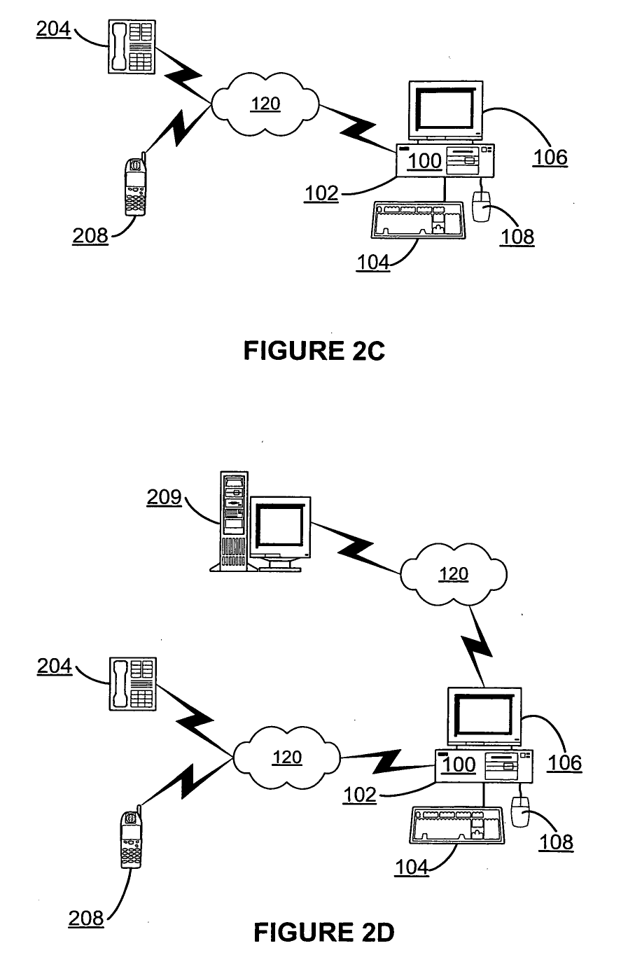

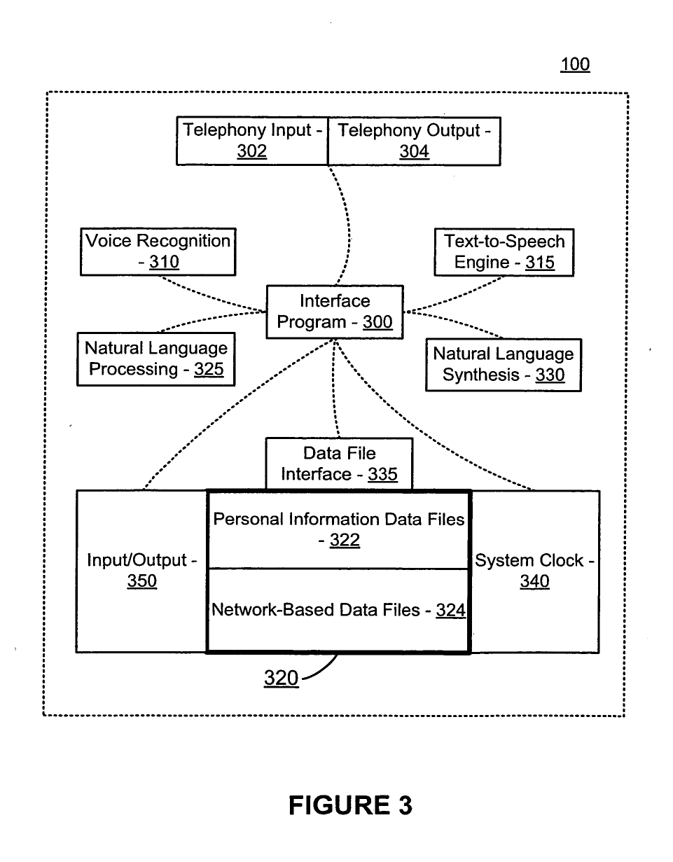

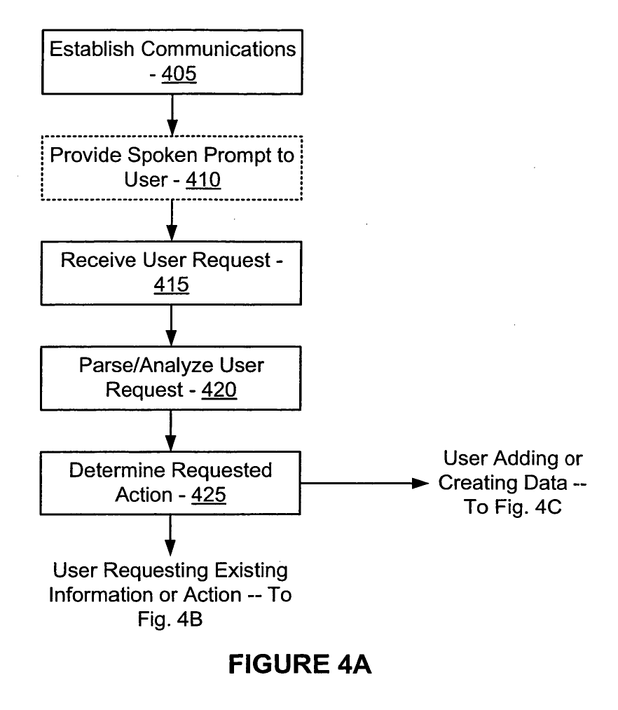

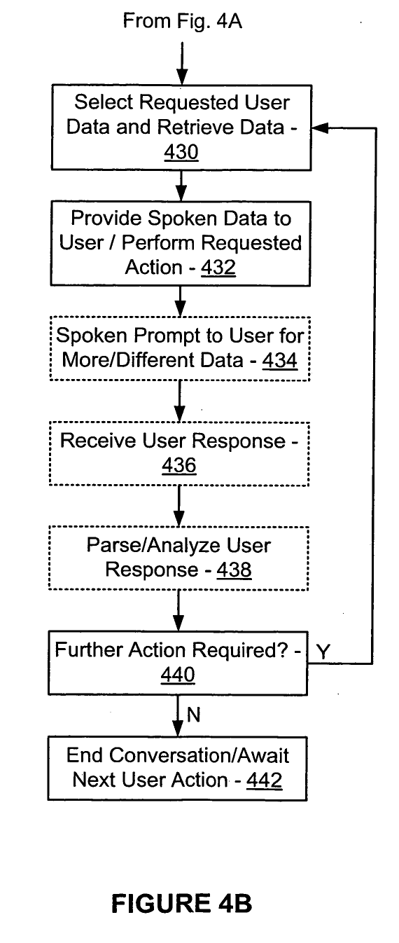

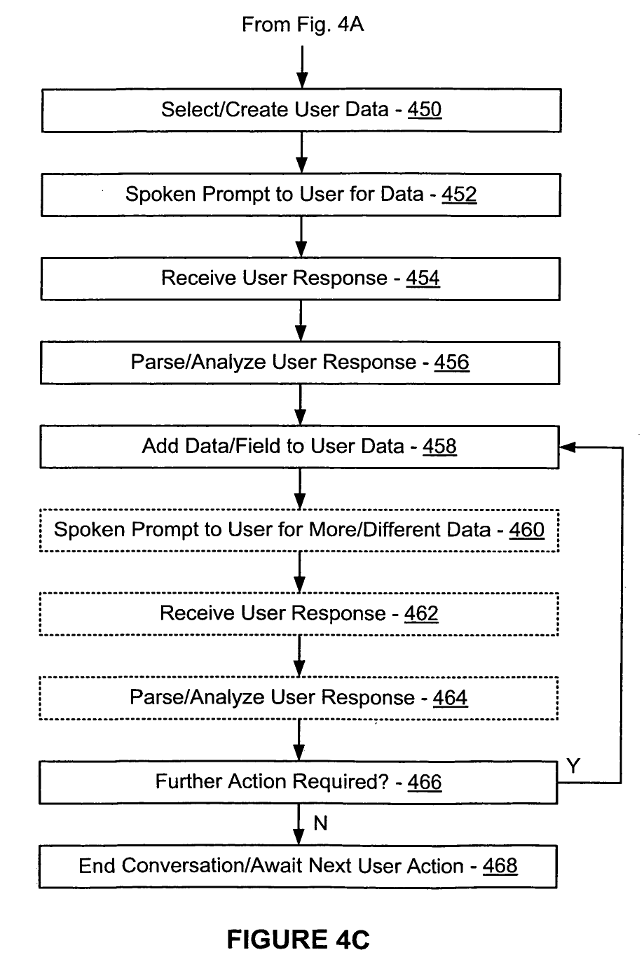

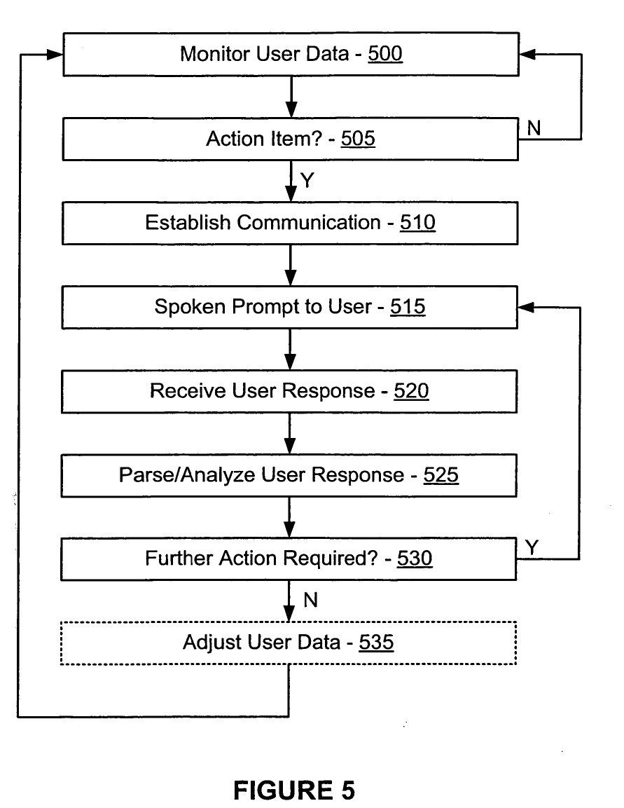

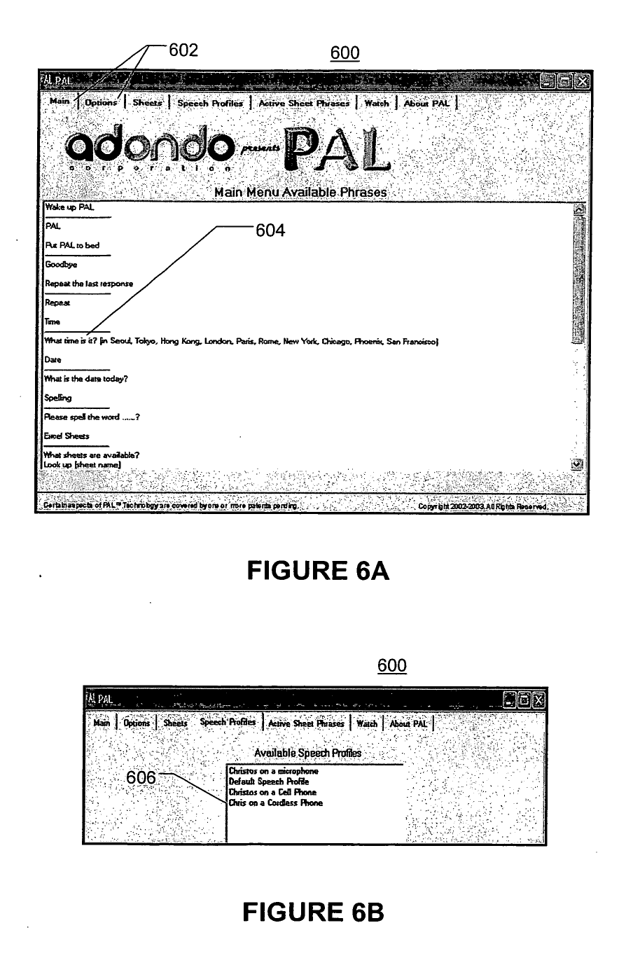

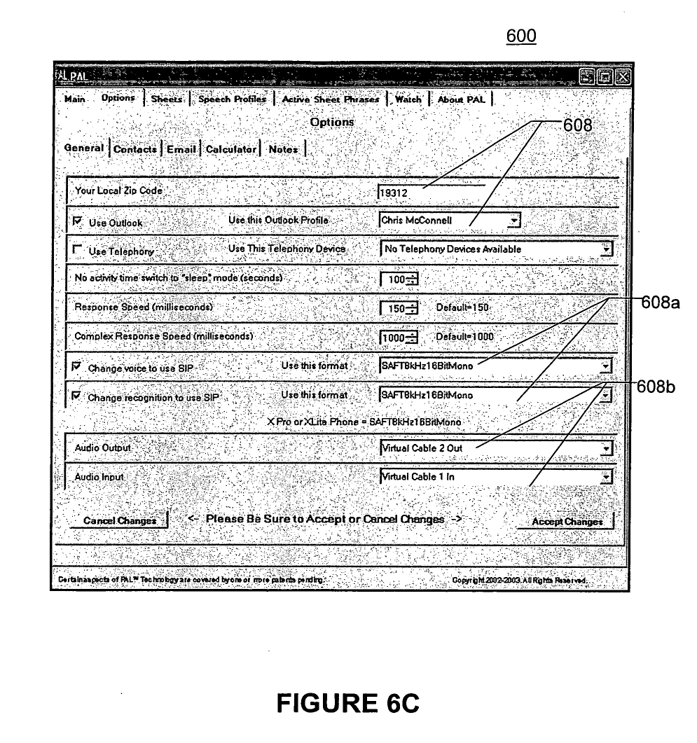

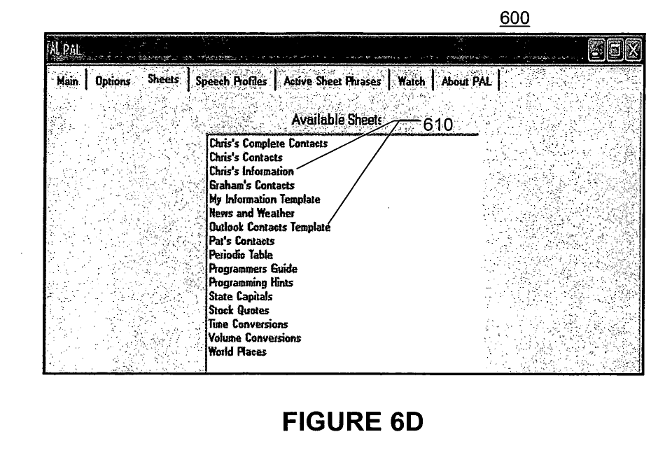

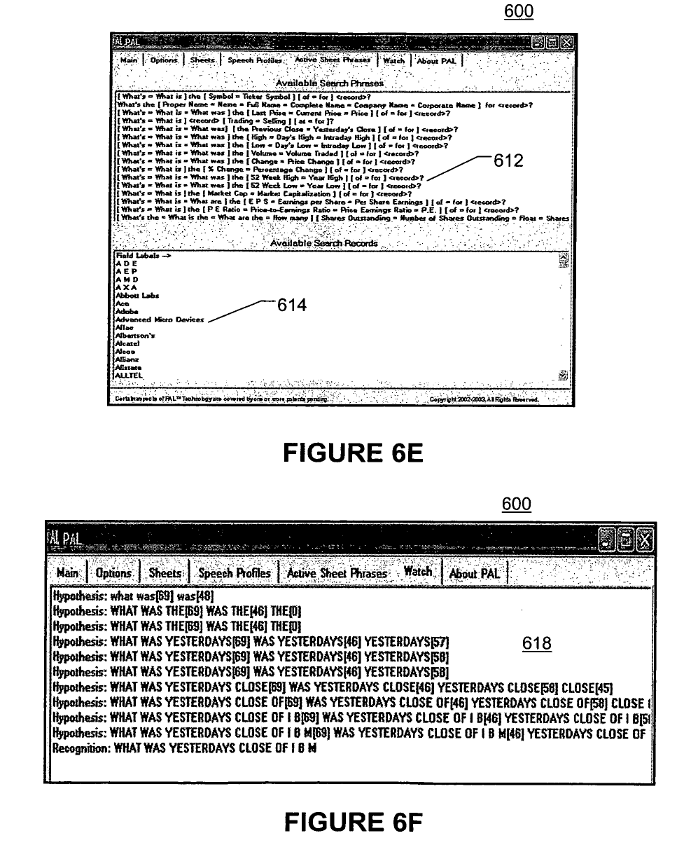

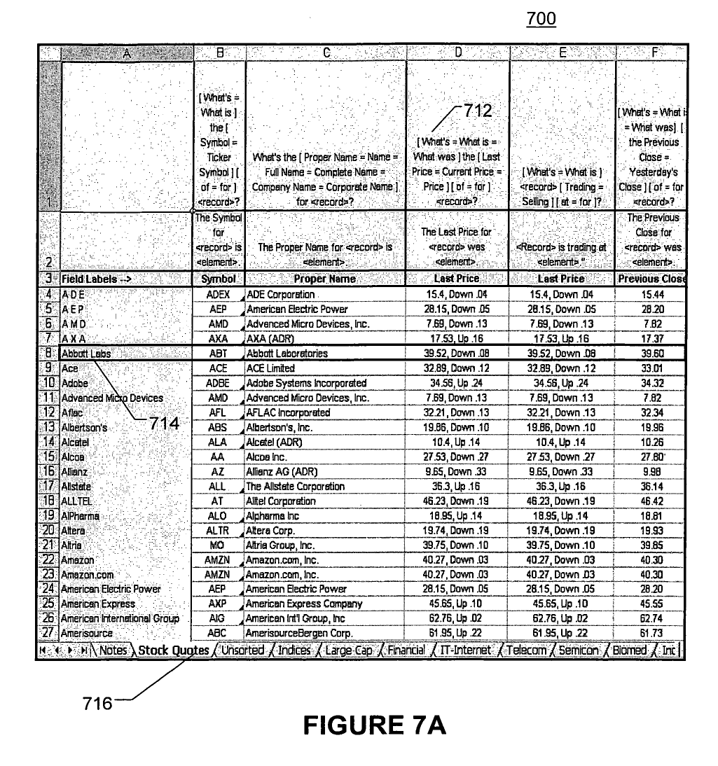

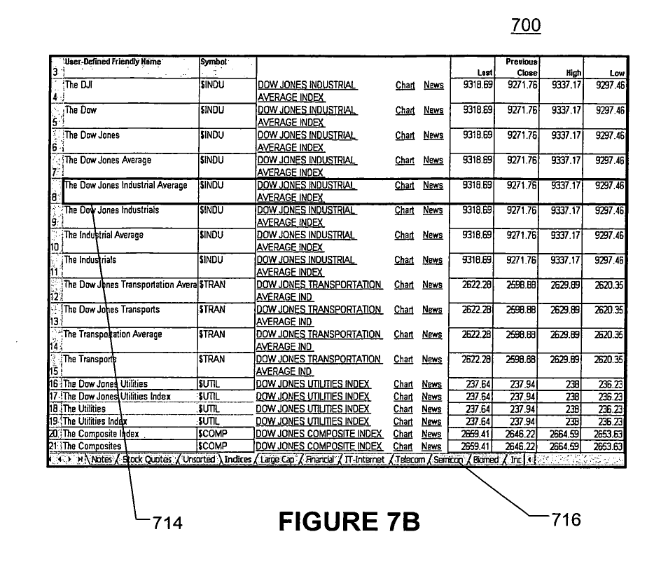

An example of such a computer, in accordance with one embodiment, is illustrated below in connection with FIG. 1. Likewise, exemplary device configurations of a computer and one or more remote communications devices is illustrated below in connection with FIGS. 2A-D. As noted above, an interface program operatively interconnects software and/or hardware for the purpose of implementing an embodiment of the present invention, and an exemplary configuration of such program and software is discussed below in connection with FIG. 3. An exemplary method of a user-initiated transaction is illustrated below in connection with FIGS. 4A-C, and an exemplary method of a computer-initiated transaction is illustrated below in connection with FIG. 5. FIGS. 6A-F illustrate exemplary configurations of software and/or hardware components and programs according to one embodiment of the present invention. Finally, FIGS. 7A-B illustrate an exemplary configuration of a spreadsheet according to an embodiment. In the following discussion, it will be appreciated that details of implementing such software and/or hardware components and communications devices, as well as the technical aspects of interoperability, should be known to one of skill in the art and therefore such matters are omitted herein for clarity.

Turning now to FIG. 1, an exemplary computer 100 in which aspects of the present invention may be implemented is illustrated. Computer 100 may be any general purpose or specialized computing device capable of performing the methods discussed herein. In one embodiment, computer 100 comprises CPU housing 102, keyboard 104, display device 106 and mouse 108. It will be appreciated that computer 100 may be configured in any number of ways while remaining consistent with an embodiment of the present invention. For example, computer 100 may have an integrated display device 106 and CPU housing 102, as would be the case with a laptop computer. In another embodiment, computer 100 may have an alternative means of accepting user input, in place of or in conjunction with keyboard 104 and/or mouse 108. In an embodiment, program 130 such as the interface program, a software component or the like is displayed on the display device 106. Such an interface program and software component will be discussed below in connection with FIGS. 3 and 6.

In an embodiment, computer 100 is also operatively connected to network 120 such as, for example, the Internet, an intranet or the like. Computer 100 further comprises processor 112 for data processing, memory 110 for storing data, and input/output (I/O) 114 for communicating with network 120 and/or another communications medium such as a telephone line or the like. It will be appreciated that processor 112 of computer 100 may be a single processor, or may be a plurality of interconnected processors. Memory 110 may be, for example, RAM, ROM, a hard drive, CD-ROM, USB storage device, or the like, or any combination of such types of memory. In addition, memory 110 may be located internal or external to computer 100. I/O 114 may be any hardware and/or software component that permits a user or external device to communicate with computer 100. The I/O 114 may be a plurality of devices located internally and/or externally.

Turning now to FIGS. 2A-D, diagrams of exemplary computer configurations in which aspects of the present invention may be implemented are illustrated. In FIG. 2A, computer 100 having housing 102, keyboard 104, display device 106 and mouse 108, as was discussed above in connection with FIG. 1, is illustrated. In addition, a microphone 202 and speaker 203 are operatively connected to computer 100. As may be appreciated, microphone 202 is adapted to receive sound waves and convert such waves into electrical signals that may be interpreted by computer 100. Speaker 203 performs the opposite function, whereby electrical signals from computer 100 are converted into sound waves. As may be appreciated, a user may speak into microphone 202 so as to issue commands or requests to computer 100, and computer 100 may respond by way of speaker 203. Conversely, computer 100 may initiate a “conversation” with a user by making a statement or playing a sound by way of speaker 203, by displaying a message on display device 106, or the like. As can be seen in FIG. 2A, an optional corded or cordless telephone or speakerphone may be connected to computer 100 by way of, for example, a telephone gateway connected to the computer 100, such as an InternetPhoneWizard manufactured by Actiontec Electronics, Inc. of Sunnyvale, Calif., in addition to or in place of any of keyboard 104, mouse 108, microphone 202 and/or speaker 203. As may be appreciated, telephone 210, in one embodiment, such as a conventional corded or cordless telephone or speakerphone acts as a remote version of microphone 202 and speaker 203, thereby allowing remote interaction with computer 100. One example of telephone 210 designed specifically to connect to computer 100 is the Clarisys i750 Internet telephone by Clarysis of Elk Grove Village, Ill.

In FIG. 2B, computer 100 having housing 102, keyboard 104, display device 106 and mouse 108, as was discussed above in connection with FIG. 1, is again illustrated. In addition, computer 100 is operatively connected to local telephone 206. As may be appreciated, in one embodiment computer 100 is connected directly to a telephone line, without the need for an external telephone to be present. Computer 100 may be adapted to receive a signal from a telephone line, for example by way of I/O 114 (replacing local telephone 206 and not shown in FIG. 2B for clarity). In such an embodiment, I/O 114 is a voice modem or equivalent device. Optional remote telephone 204 and/or cellular telephone 208 may also be operatively connected to local telephone 206 or to a voice modem. In yet another embodiment, local telephone 206 is a cellular telephone, and communication with computer 100 occurs via a cellular telephone network.

For example, in one embodiment, a user may call a telephone number corresponding to local telephone 206 by way of remote telephone 204 or cellular phone 208. In such an embodiment, computer 100 monitors all incoming calls for a predetermined signal or the like, and upon detecting such signal, the computer 100 forwards such information from the call to the interface program or other software component. In such a manner, computer 100 may, upon connecting to the call, receive a spoken command or request from the user and issue a response. Conversely, computer 100 may initiate a conversation with the user by calling the user at either remote telephone 204 or cellular phone 208. As may be appreciated, computer 100 may have telephone-dialing capabilities, or may use local telephone 206, if present, to accomplish the same function.

It will be appreciated that telephone 204-208 may be any type of instrument for reproducing sounds at a distance in which sound is converted into electrical impulses (in either analog or digital format) and transmitted either by way of wire or wirelessly by, for example, a cellular network or the like. As may be appreciated, an embodiment's use of a telephone for remotely accessing computer 100 ensures relatively low cost and ready availability of handsets for the user. In addition, any type or number of peripherals may be employed in connection with a telephone, and any such type of peripheral is equally consistent with an embodiment of the present invention. In addition, any type of filtering or noise cancellation hardware or software may be used—either at a telephone such as telephones 204-208 or at the computer 100—so as to increase the signal strength and/or clarity of the signal received from such telephone 204-208.

Local telephone 206 may, for example, be a corded or cordless telephone for use at a location remote from the computer 100 while remaining in a household environment. In an alternate embodiment such as, for example, in an office environment, multi-line and/or long-range cordless telephone(s) may be used in connection with the present invention. It will be appreciated that while an embodiment of the present invention is described herein in the context of a single user operating single telephone 204-208, any number of users and telephones 204-208 may be used, and any such number is consistent with an embodiment of the present invention. As mentioned previously, local telephone 206 may also be a cellular telephone or other device capable of communicating via a cellular telephone network.

Devices such as pagers, push-to-talk radios, and the like may be connected to computer 100 in addition to or in place of telephones 204-208. As will be appreciated, all or most of the user's information is stored in computer 100. Therefore, if a remote communications device such as, for example, telephones 204-208 are lost, the user can quickly and inexpensively replace the device without any loss of data.

Turning now to FIG. 2C, computer 100 having housing 102, keyboard 104, display device 106 and mouse 108, as was discussed above in connection with FIG. 1, is once again illustrated. In contrast to the embodiment illustrated above in connection with FIG. 2B, computer 100 is operatively connected to remote telephone 204 and/or cellular telephone 208 by way of network 120. As may be appreciated, computer 100 may be operatively connected to the network 120 by way of, for example, a dial-up modem, DSL, cable modem, satellite connection, T1 connection or the like. For example, a user may call, either a “web phone” number, conventional telephone number which has been assigned to computer 100 or the like to connect to computer 100 by way of network 120. Likewise, computer 100 may connect to remote telephone 204 and/or cellular phone 208 by way of network 120. In such an embodiment, it will be appreciated that computer 100 either has onboard or is in operative communications with telephone-dialing functionality in order to access network 120. Such functionality may be provided by hardware or software components, or a combination thereof, and will be discussed in greater detail below in connection with FIG. 4B.

An example of how such telephone communication may be configured is by way of a Voice Over Internet Protocol (VoIP) connection. In such an embodiment, any remote phone may be able to dial computer 100 directly, and connect to the interface program by way of an aspect of network 120. Such an interface program is discussed in greater detail below in connection with FIGS. 3 and 6A-F. It will be appreciated that in an alternate embodiment, a SIP device (for example, a SIP telephone 204-208, which is based on Session Initiation Protocol), or even instant messaging technology or the like, could be used to communicate with computer 100.

In FIG. 2D, computer 100 having housing 102, keyboard 104, display device 106 and mouse 108, as was discussed above in connection with FIG. 1, is once again illustrated. Consistent with the embodiment shown in connection with FIG. 2C, computer 100 is operatively connected to remote telephone 204 and/or cellular telephone 208 by way of network 120. In addition, computer 100 is operatively connected to remote computer 209 by way of network 120. As may be appreciated, remote computer 209 may be another personal computer, a server, a router, a network PC, a peer device or other network node, and typically includes many or all of the elements described above relative to computer 100. It will be further appreciated that while an embodiment of the present invention is described herein in the context of a single remote computer, any number of remote computers may be used, and any such number is consistent with an embodiment of the present invention.

As will be explained below, a user may access computer 100 by way of remote telephone 204 and/or cellular telephone 208 to, for example, access media content and the like provided by remote computer 209 via network 120. In an embodiment, the media content may be in the form of a media file (e.g., audio file, video file, etc.) and may be downloaded by computer 100 in its entirety. Computer 100 may then “play” the file (e.g., generate audio output from an audio file, etc.) to the user by way of remote telephone 204 and/or cellular telephone 208. Alternatively, computer 100 may also “stream” media content. For example, if the media content is available by way of an internet link, the content may be downloaded in increments and played to the user by way of remote telephone 204 and/or cellular telephone 208 as other parts of the file are being downloaded. Media content may include podcasts, songs, playlists, internet radio programming, internet video programming and any other types of media that includes audio and/or video content.

In an embodiment, remote computer 209 may be referred to as a “server.” Historically, server software was executed on a large powerful computer such as a mainframe or minicomputer. These computers have generally been replaced by computers using a more robust version of the microprocessor technology commonly used in personal computers. The term “server” has therefore been adopted to describe any microprocessor-based machine designed for this purpose. Servers may have high-capacity (and sometimes redundant) power supplies, a motherboard built for durability in 24×7 operations, large quantities of ECC RAM, and fast I/O subsystems employing technologies such as SCSI, RAID, and PCI-X or PCI Express, as should be known to one skilled in the art. Servers are not limited to executing serving software. Similarly, server software is not limited to running on servers.

The term “server” also may refer to a computer software application that carries out a task (e.g., provides a service) on behalf of another piece of software, sometimes referred to as a client. For example, in the case of the Internet, an example of a server is the Apache web server and examples of a client are the Internet Explorer and Mozilla web browsers. In the case of email and personal information, an example of a server is the Microsoft Exchange Server and an example of a client is the Microsoft Outlook application. The preceding examples are for explanation purposes only and are not exclusive or limiting. Other types of server and client software may exist for services such as printing, remote login and displaying graphical output. The services may be divided into file serving, allowing users to store and access files on a common computer, and applications serving (e.g., the software runs a computer program to carry out a task for the users). The server often provides services to multiple clients, and as a result, multiple users. Thus, the term “server” may refer to hardware (e.g., a server computer), software (e.g., server software) or to any combination thereof that performs the functions of a server.

In an embodiment, computer 100 may be a microcomputer that may be used by one person at a time. Computer 100 may be suitable for general purpose tasks such as word processing, programming, sending and receiving messages and/or files to other computers, multimedia editing and gaming. In an embodiment, computer 100 executes software not written by the user and may be used to execute client software with which the server software interacts.

Thus, several exemplary configurations of a user computer 100 in which aspects of the present invention may be implemented are presented. As may be appreciated, any manner of operatively connecting a user to computer 100, whereby the user may verbally communicate with such computer 100, is equally consistent with an embodiment of the present invention.

As may also be appreciated, therefore, any means for remotely communicating with computer 100 is equally consistent with an embodiment of the present invention. Additional equipment may be necessary for such computer 100 to effectively communicate with such remote communications device, depending on the type of communications medium employed. For example, the input to a speech recognition engine generally is received from a standard input such as a microphone. Similarly, the output from a text-to-speech engine, a media player or other speech or sound generating program generally is sent to a standard output device such as a speaker. In the same manner, a communications device, such as a cellular telephone, may be capable of receiving input from a (headset) microphone and transmitting output to a (headset) speaker. Accordingly, an embodiment of the present invention provides connections between the speech engines and a communications device directly connected to the computer (e.g., telephone 206 as shown in FIG. 2B), so the output from the device—which would generally go to a speaker—is transferred to the input of the speech engine (which would generally come from a microphone). Likewise, there needs to be a connection between the output from the text-to-speech engine and the media player (which would also normally go to a speaker) to the input of the device in such a manner that the device will then forward the audio output to a remote caller.

In a basic embodiment, such transference is accomplished between telephone 206 that is external to the computer using patch-cords (as in FIG. 2B). In some embodiments; however, the signals not only require transference, but also conditioning. For example, if the audio signals are analog, one embodiment requires impedance matching such as can be done with a variable resistor, volume control and so forth. If the audio signals are digital, the format (e.g., sample rate, sample bits (block size), and number of channels) must be conditioned.

Another embodiment of such signal transference and conditioning involves “softphone” software, operating at computer 100 in conjunction with the interface program. Such software facilitates Internet-based telephony (as provided by companies such as Vonage and Skype) and receives telephone calls on computer 100 using the Session Initiation Protocol (SIP) standard or other protocols such as H.323. One example of such software is X-PRO, which is manufactured by Xten Networks, Inc., of Burnaby, British Columbia, Canada. Another example is the softphone provided by Skype. Softphone software generally sends telephonic sound to a user by way of local speakers or a headset, and generally receives telephone voice by way of a local microphone. Often the particular audio devices to be used by the softphone software can be selected as a user setting, as sometimes computer 100 has multiple audio devices available. As noted above, text-to-speech software generally sends sound (output) to its local user by way of local speakers or a headset; and, speech recognition software generally receives voice (input) by way of a local microphone. Accordingly, the softphone software must be linked by an embodiment of the present invention to the text-to-speech software and the speech recognition software. In embodiments that use additional software, such as media player software, such software should be linked by an embodiment to the softphone software. Such a linkage may be accomplished in any number of ways and involving either hardware or software, or a combination thereof. In one embodiment, a hardware audio device is assigned to each application, and then the appropriate output ports and input ports are linked using patch cables. Such an arrangement permits audio to flow from the softphone to the speech recognition software, and from the media player software and/or text-to-speech software to the softphone software. As may be appreciated, such an arrangement entails connecting speaker output ports to microphone input ports and therefore in one embodiment impedance-matching in the patch cables is used to mitigate sound distortion.

Another embodiment uses special software to link the audio signals between applications. An example of such software is Virtual Audio Cable (software written by Eugene V. Muzychenko), which emulates audio cables entirely in software, so that different software programs that send and receive audio signals can be readily connected. In such an embodiment, a pair of Virtual Audio Cables are configured to permit audio to flow from the softphone to the speech recognition software, and from the media player software and/or text-to-speech software to the softphone software. In yet another embodiment, the softphone software, the text-to-speech software and the speech recognition software—and the media player software or the like, if present—are modified or otherwise integrated so the requirement for an external audio transference device is obviated entirely.

Turning now to FIG. 3, a block diagram of an exemplary software and/or hardware configuration in accordance with an embodiment of the present invention is illustrated. As may be appreciated, in one embodiment of the present invention, such software is run by computer 100. In such a manner, the computing power of computer 100 is utilized, rather than attempting to implement such software on a remote communications device such as, for example, telephones 204-210 as discussed above in connection with FIGS. 2A-D (not shown in FIG. 3 for clarity).

It will be appreciated that each software and/or hardware component illustrated in FIG. 3 is operatively connected to at least one other software and/or hardware component (as illustrated by the dotted lines). In addition, it will be appreciated that FIG. 3 illustrates only one embodiment of the present invention, as other configurations of software and/or hardware components are consistent with an embodiment as well. It will be appreciated that the software components illustrated in FIG. 3 may be stand-alone programs, application program interfaces (APIs) or the like. Importantly, some software components already may be present, thus substantially lowering costs, reducing complexity, saving hard disk space, and improving efficiency.

Telephony input 302 is any type of component that permits a user to communicate by way of spoken utterances and/or other audio commands (e.g., Dual Tone Multi-Frequency (DTMF) signals generated by a keypad) with computer 100 via, for example, input devices as discussed above in connection with FIGS. 2A-D. Likewise, telephony output 304 is provided for outputting electrical signals as sound for a user to hear. It will be appreciated that both telephony input 302 and telephony output 304 may be adapted for other purposes such as, for example, receiving and transmitting signals to a telephone or to network 120, including having the functionality necessary to establish a connection by way of such telephone or network 120. Telephony input 302 and output 304 may be hardware internal or external to the computer 100. For example, telephony input 302 and output 304 may be part of a network interface card, a modem or any type of telephony interface device. According to an embodiment, a telephony interface device may be any type of device that allows communication with a computer by way of any form of telephony, whether digital (e.g., VoIP, etc.) or analog (e.g., POTS, etc.) in nature. In addition, telephony input 302 and output 304 may be a part of software such a softphone application.

Also provided is voice recognition software 310 which, as the name implies, is adapted to accept an electronic signal—such as a signal received by telephony input 302—wherein the signal represents a spoken utterance by a user, and to decipher such utterance. Voice recognition software 310 may be, for example, any type of specialized or off-the-shelf voice recognition software. Voice recognition software 310 may include user training for better-optimized speech recognition. In addition, text-to-speech engine 315 for communicating with a user is illustrated. Text-to-speech engine 315, in an embodiment, generates spoken statements from electronic data, that are then transmitted to the user. In an embodiment as illustrated in FIG. 3, natural language processing module 325 and natural language synthesis module 330 are provided to interpret and construct, respectively, spoken statements.

User data 320 comprises any kind of information that is stored or accessible to computer 100, that may be accessed and used in accordance with an embodiment of the present invention. For example, personal information data file 322 may be any type of computer file that contains any type of information. Email, appointment files, personal information and the like are examples of the type of information that is stored in a personal information database. Additionally, personal information data file 322 may be a type of file such as, for example, a spreadsheet, database, document file, media file, email data, and so forth. Media files may include, for example, podcasts, songs, playlists, or the like. “Podcasting” is a blanket term used to describe a collection of technologies for automatically distributing audio and/or video programs over the Internet via a publish and subscribe model. Podcasting is a combination of the words “broadcasting” and “iPod,” even though an iPod® is not required to play a podcast. By way of example, and not limitation, podcasts may include “blogcasting,” “audioblogging” and “rsscasting.”

Podcasting may enable a publisher to publish a list of programs in a special format on the web, often referred to as a “feed.” The feed may be referred to as a subscription site, which may be a web page with a designated web address (e.g., a URL). The web page may consist of programming language and links to one or more media files that a user may listen to or view when the user plays the podcast. The publisher may update the subscription site with new and more recent media files as desired.

A user who wishes to hear or see a podcast may subscribe to the feed using, for example, “podcatching” software (e.g., an aggregator), which may periodically check the feed and automatically download new media files as they become available. The podcatching software may also transfer the program to a computer or portable media player. Any digitial media player or computer with media player software may play podcasts.

In addition to the types of files noted above, data file 322 (as well as data file 324, below) may be able to perform tasks at the user's direction such as, for example, open a garage door, print a document, send a fax, send an e-mail, turn on and/or control a household appliance, record or play a television or radio program, interface with communications devices and/or systems, and so forth. Such functionality may be included in data file 322-324, or may be accessible to data file 322-324 by way of, for example, telephony input 302 and output 304, Input/Output 350, and/or the like. It will be appreciated that interface program 300 may be able to carry out such tasks using components, such as those discussed above, that are internal to computer 100, or program 300 may interface—using telephony input 302 and output 304, Input/Output 350, and/or the like—with devices external to computer 100.

An additional file that may be accessed by computer 100 on behalf of a user is a network-based data file 324. Data file 324 may contain macros, XML tags, or other functionality that accesses a network 120, such as the Internet, to obtain up-to-date information from remote computer 209 or the like on behalf of the user. Such information may be, for example, stock prices, weather reports, news, media content (e.g., audio files, video files, podcasts, internet radio programming, internet video programming, etc.) and the like. In an embodiment, interface program 300 may connect to an Internet web page or a subscription site by accessing the URL of that page or subscription site. The web page or subscription site may include programming code, text and/or links to available media content. The media content may be located on computers that are accessible via the Internet.

In an embodiment, interface program 300 may conduct a search of the programming code, text, and/or links and use a matching technique to create a list of links to all or some of the media content based on criteria defined in the search and matching technique. Interface program 300 may pass the resulting list of media content to data file interface 335, which may play and/or stream the media content. In addition, if the media content is in the form of a media file, interface program 300 may download the media file to computer 100 and then data file interface 335 may play the media file. It will be appreciated by one of ordinary skill in the art that media files may be streamed instead of downloaded in their entirety prior to playback. In fact, any method of extracting the information contained within the media content is equally consistent with an embodiment. For example, data file interface 335 may begin playing the media file before the file is completely downloaded. By doing so, the response time from the user request to the start of playing may be reduced. Data file interface 335 may also send the output to speaker 203, remote telephone 204, cellular telephone 208, or any other device capable of playing audio and/or video.

Interface program 300 also may navigate through the playlist of media files that are played by data file interface 335. For example, based on commands from the user, data file interface 335 may pause and later resume playing a particular media file. Data file interface 335 may also skip forward or skip back within an individual media file, skip forward to subsequent media files in the playlist, or skip back to previous media files in the playlist. Data file interface 335 may skip by varying degrees based upon the playing time and/or size of the media file. By way of example, and not limitation, data file interface 335 may skip slightly forward by ten seconds and skip far forward by one minute. The same criteria may apply when skipping back.

Another example of such a data file 324 will be discussed below in the context of an Internet-enabled spreadsheet in FIGS. 7A-B. As will be appreciated, the term user data 320 as used herein refers to any type of data file including data files 322 and/or 324. Data file interface 335 is provided to permit interface program 300 to access user data 320. As may be appreciated, there may be a single data file interface 335, or a plurality of interfaces 335 which may interface only with specific files or file types. For example, data file interface 335 may comprise one or more media players that permit interface program 300 to access and play various types of media content, such as MPEG layer 3 (MP3), Windows Media Audio (WMA), Waveform Audio (WAV), MPG, MPEG, Windows Media Video (WMV), and the like. Such a media player may also permit interface program 300 to “stream” audio and/or video data, whereby the data is played as it is downloaded from remote computer 209 or the like, rather than after the data has been downloaded in its entirety. Also, in one embodiment, a system clock 340 is provided for enabling the interface program 300 to determine time and date information. In addition, in an embodiment an Input/Output 350 is provided for interfacing with external devices, components, and the like. For example, Input/Output 350 may comprise one or more of a printer port, serial port, USB port, and/or the like.

Operatively connected (as indicated by the dotted lines) to the aforementioned hardware and software components is the interface program 300. Details of an exemplary user interface associated with such interface program 300 are discussed below in connection with FIGS. 6A-F. However, interface program 300 itself is either a stand-alone program, or a software component that orchestrates the performance of tasks in accordance with an embodiment of the present invention. For example, interface program 300 controls the other software components, and also controls what user data 320 is open and what “grammars” (expected phrases to be uttered by a user) are listened for.

It will be appreciated that interface program 300 need not itself contain user data 320 in which the user is interested. In such a manner, interface program 300 remains a relatively small and efficient program that can be modified and updated independently of any user data 320 or other software components as discussed above. In addition, such a modular configuration enables interface program 300 to be used in any computer 100 that is running any type of software components. As a result, compatibility concerns are alleviated. Furthermore, it will be appreciated that the interface program's 300 use of components and programs that are designed to operate on computer 100, such as a personal computer, enables sophisticated voice recognition to occur in a non-server computing environment. Accordingly, interface program 300 interfaces with programs that are designed to run on computer 100—as opposed to a server—and are familiar to a computer 100 user. For example, such programs may be preexisting software applications that are part of, or accessible to, an operating system of computer 100. As may be appreciated, such programs may also be stand-alone applications, hardware interfaces, and/or the like.

It will also be appreciated that the modular nature of an embodiment of the present invention allows for the use of virtually any voice recognition software 310. However, the large variances in human speech patterns and dialects limits the accuracy of any such recognition software 310. Thus, in one embodiment, the accuracy of such software 310 is improved by limiting the context of the spoken material software 310 is recognizing. For example, if software 310 is limited to recognizing words from a particular subject area, software 310 is more likely to correctly recognize an utterance—that may sound similar to any number of unrelated words—as a word that is related to the desired subject area. Therefore, in one embodiment, user data 320 that is accessed by interface program 300 is configured and organized in such a manner as to perform such context limiting. Such configuration can be done in user data 320 itself, rather than requiring a change to interface program 300 or other software components as illustrated in FIG. 3.

For example, a spreadsheet application such as Microsoft® Excel or the like provides a means for storing and accessing data in a manner suitable for use with interface program 300. Script files, alarm files, look-up files, command files, solver files and the like are all types of spreadsheet files that are available for use in an embodiment of the present invention. The use of a spreadsheet in connection with an embodiment of the present invention will be discussed in detail in connection with FIG. 7A, below.

A script file is a spreadsheet that provides for a spoken dialogue between a user and computer 100. For example, in one embodiment, one or more columns (or rows) of a spreadsheet represent a grammar that may be spoken by a user—and therefore will be recognized by the interface program 300- and one or more columns (or rows) of the spreadsheet represent the computer's 100 response. Thus, if a user says, for example, “hello,” computer 100 may say “hi” or “good morning” or the like. Such a script file thereby enables a more user-friendly interaction with computer 100.

An alarm file, in one embodiment, has entries in one or more columns (or rows) of a spreadsheet that correspond to a desired function. For example, an entry in the spreadsheet may correspond to a reminder, set for a particular date and/or time, for the user to take medication, attend a meeting, etc. In addition, an entry may correspond to a notification to alert the user of the availability of a new data and/or media content (e.g., podcast, song, etc.). Thus, interface program 300 interfaces with a component such as telephony output 304 to contact the user and inform the user of the reminder or notification. Thus, it will be appreciated that an alarm file is, in some embodiments, always active because it must be running to generate an action upon a predetermined condition.

A look-up file, in one embodiment, is a spreadsheet that contains information or is cross-referenced to information. In one embodiment, the information is contained entirely within the look-up file, while in other embodiments the look-up file references information from data sources outside of the look-up file. For example, spreadsheets may contain cells that reference data that is available on the Internet (using, for example, “smart tags” or the like), and that can be “refreshed” at a predetermined interval to ensure the information is up-to-date. The smart tags may link to, for example, internet radio and/or video programming. Furthermore, the spreadsheets may contain cells that reference files that are available for download on the Internet. Therefore, a look-up file may be used to find and download information for a user such as, for example, stock quotes, sports scores, weather conditions, media content and the like. As noted above, the information may also be streamed instead of downloaded in its entirety prior to playback. It will be appreciated that such information may be stored locally or remote to computer 100.

A command file, in one embodiment, is a spreadsheet that allows a user to input commands to computer 100 and to cause interface program 300 to interface with an appropriate component to carry out the command. For example, the user may wish to hear a song, and therefore interface program 300 interfaces with a media player to play the song. As noted above, in such an embodiment the song may be stored locally, downloaded partially or in its entirety from remote computer 209 or the like, streamed from remote computer 209 or the like, etc. In another example, the user may wish to hear internet radio programming, and therefore interface program 300 interfaces with the media player, accesses the radio programming via the Internet and streams the media content to the user. A solver file, in one embodiment, allows a user to solve mathematical and other analytical problems by verbally querying computer 100.

In each type of file, the data contained therein are organized in a series of rows and/or columns, which include “grammars” or links to grammars which voice recognition software 310 must recognize to be able to determine the data to which the user is referring. As noted above, an exemplary spreadsheet used by an embodiment of the present invention is discussed below in connection with FIGS. 7A-B.

As noted above, a script file represents a simple application of spreadsheet technology that may be leveraged by interface program 300 to provide a user with the desired information or to perform the desired task. It will be appreciated that, depending on the particular voice recognition software 310 being used in an embodiment, the syntax of such scripts affects what such software is listening for in terms of a spoken utterance from a user. As will be discussed below in connection with FIG. 7A, an embodiment of the present invention provides flexible grammars, as well as a user-friendly way of programming such grammars, so a user does not have to remember an exact statement that must be spoken in order to cause computer 100 to perform a desired task.

An embodiment is configured so as to only open, for example, a lookup file when requested by a user. In such a manner, the number of grammars that computer 100 must potentially decipher is reduced, thereby increasing the speed and reliability of any such voice recognition. In addition, such a configuration also frees up computer 100 resources for other activities. If a user desires to open such a file, the user may issue a verbal command such as, for example, “look up stock prices” or the like. Computer 100 then determines which data file 322-324, or the like corresponds to the spoken utterance and opens it. Computer then 100 informs the user, by way of a verbal cue, that the data is now accessible.

In an alternate embodiment, the user would not complete the spreadsheets or the like using the standard spreadsheet technology. Instead, a wizard, API or the like may be used to fill, for example, a standard template file. In another embodiment, the speech recognition technology discussed above may be used to fill in such a template file instead of using keyboard 104 or the like. In yet another embodiment, interface program 300 may prompt the user with a series of spoken questions, to which the user speaks his or her answers. In such a manner, computer 100 may ask more detailed questions, create or modify user data 320, and so forth. Furthermore, in yet another embodiment, a wizard converts an existing spreadsheet, or one downloaded from the Internet or the like, into a format that is accessible and understandable to interface program 300.

Therefore, in such an exemplary configuration as illustrated in FIG. 3, interface program 300, according to an embodiment of the present invention, is able to send information to and receive such information from a user. Such information may contain user data 320, that may be contained within computer 100 (such as, for example, in memory 110), in a network 120 such as the Internet, and/or the like. A method of performing such tasks is therefore now discussed in connection with FIGS. 4 and 5, below.

Turning now to FIGS. 4A-C, flowcharts of an exemplary method of a user-initiated transaction in accordance with an embodiment of the present invention are shown. As was noted in the discussion of alarm scripts in connection with FIG. 3, above, it will be appreciated that in one embodiment interface program 300, by way of telephony output 304, is able to initiate a transaction as well. Such a situation is discussed below in connection with FIG. 5.

At step 405, a user establishes communications with the computer 100. Such an establishment may take place, for example, by the user calling the computer 100 by way of a cellular phone 208 as discussed above in connection with FIGS. 2B-D. It will be appreciated that such an establishment may also have intermediate steps that may, for example, establish a security clearance to access the user data 320 or the like. At optional step 410, a “spoken” prompt is provided to the user. Such a prompt may simply be to indicate to the user that the computer 100 is ready to listen for a spoken utterance, or such prompt may comprise other information such as a date and time, or the like.

At step 415, a user request is received by way of, for example, telephony input 302 or the like. At step 420, the user request is parsed and/or analyzed to determine the content of the request. Such parsing and/or analyzing is performed by, for example, voice recognition module 310 and/or the natural language processing module 325. At step 425, the desired function corresponding to the user's request is determined. It will be appreciated that steps 410-425 may be repeated as many times as necessary for, for example, voice recognition software 310 to recognize the user's request. Such repetition may be necessary, for example, when the communications channel by which the user is communicating with computer 100 is of poor quality, the user is speaking unclearly, or for any other reason.

If the determination of step 425 is that the user is requesting existing information or for computer 100 to perform an action, the method proceeds to step 430 of FIG. 4B. For example, the user may wish to have the computer 100 read his or her appointments for the following day, download and/or play media content, or find out current stock quotes, as will be discussed below in connection with FIGS. 7A-B. If instead the determination of step 425 is that the desired function corresponding to the user request is to add or create data, the method proceeds to step 450 of FIG. 4C. For example, the user may wish to record a message, enter a new phone number for an existing or new contact, and/or the like.

Thus, and turning now to FIG. 4B, at step 430 the requested user data 320 is selected and retrieved by interface program 300. As noted above in connection with FIG. 3, an appropriate data file interface 335 is activated by the interface program 300 to interact with user data 320 and access the requested information. Alternatively, such an interface 335 may be adapted to perform a requested action using, for example, Input/Output 350. At step 432, the interface program 300 causes either the text-to-speech engine 315 and/or the natural language synthesis component 330 to generate a spoken answer based on the information retrieved from the user data 320, and/or causes a desired action to occur (e.g., download and/or play media content). If the requested data requires it, at optional step 434 a spoken prompt is again provided to the user to request additional user data 320, or to further clarify the original request. At optional step 436, a user response is received, and at optional step 438 the response is again parsed and/or analyzed. If data file interface 335 is currently playing a media file, the user may issue a response or command to, for example, stop, pause, fast forward, rewind, or skip to the next media file. It will be appreciated that such optional steps 434-438 are performed as discussed above in connection with steps 410-420 of FIG. 4A. It will also be appreciated that such steps 434-438 are optional because if the desired function is for the interface program 300 to perform an action (such as, for example, to open a garage door, send a fax, print a document, download and/or play media content, or the like) no response may be necessary, although a response may be generated anyway (e.g., to inform the user that the action was carried out successfully). At step 440, a determination is made as to whether further action is required. If so, the method returns to step 430 for further user data 320 retrieval. If no further action is required, at step 442 the conversation ends (if, for example, the user hangs up the telephone) or is placed in a standby mode to await further user input.

It will be appreciated that the determination of step 425 could result in a determination that the user is requesting a particular action be performed. For example, the user may wish to initiate a phone call. In such an embodiment, interface program 300 directs Session Initiation Protocol (SIP) softphone software by way of telephony input and output 302 and 304, Input/Output 350, and/or the like (not shown in FIG. 4B for clarity) to place a call to a telephone number as directed by the user. In another embodiment, the user could request a call to a telephone number that resides in, for example, the Microsoft® Outlook® or other contact database. In such an embodiment the user requests that interface program 300 call a particular name or other entry in the contact database and program 300 causes the SIP softphone to dial the phone number associated with that name or other entry in the contact database. It will be appreciated that, while the present discussion relates to a single telephone call, any number of calls may be placed or connected, thereby allowing conference calls and the like.

When placing a call in such an embodiment, interface program 300 initiates, for example, a conference call utilizing the SIP phone, such that the user and one or more other users are connected together on the same line and, in addition, have the ability to verbally issue commands and request information from the program. Specific grammars would enable the program to “listen” quietly to the conversation among the users until the program 300 is specifically requested to provide information and/or perform a particular activity. Alternatively, the program 300 “disconnects” from the user once the program has initiated the call to another user or a conference call among multiple users.

It will be further appreciated that the determination of step 425 could result in a determination that the user wishes to access media content available on the Internet. In such an embodiment, the interface program 300 may locate the requested content and download and/or stream the content via network 120. For example, if the user wishes to listen to an internet radio station, interface program 300 may activate the appropriate media player and stream the content via the website. Alternatively, if the media content is located on a local hard drive, for example, interface program 300 may activate the appropriate media player to access and play the requested content from the hard drive.

As discussed above in connection with FIG. 4A, the user may desire to add or create data instead of simply requesting to retrieve such data or take a specified action. Thus, referring now to FIG. 4C, at step 450 user data 320, in the form of a new database, spreadsheet or the like—or as a new entry in an existing file—is selected or created in accordance with the user instruction received in connection with FIG. 4A, above. At step 452, a spoken prompt is provided to the user, whereby the user is instructed to speak the new data or instruction. At step 454, the user response is received, and at step 456, the response is parsed and/or analyzed. At step 458, the spoken data or field is added to the user data 320 that was created or selected in step 450. At optional step 460, if necessary, a spoken prompt is again provided to the user to request additional new data. At optional step 462, such data is received in the form of the user's spoken response, and at optional step 464, such response is parsed and/or analyzed. At step 466, a determination is made as to whether further action is required. If so, the method returns to step 458 to add the spoken data or field to the user data 320. If no further action is required, at step 468 the conversation ends or is placed in a standby mode to await further user input. It will be appreciated that such prompting and receipt of user utterances takes place as discussed above in connection with FIGS. 4A-B.

In contrast to the method described above in connection with FIGS. 4A-C, the method of FIG. 5 is an exemplary method of a computer 100—initiated transaction in accordance with an embodiment of the present invention. Accordingly, and referring now to FIG. 5, at step 500 user data 320 is monitored. As may be appreciated, multiple instances of user data 320 may be monitored by interface program 300 such as, for example, an alarm file, an appointment database, an email/scheduling program file and the like. Alternatively, such user data 320 may include user-specified or automatically determined media content that is remotely located from computer 100 (or remote computer 209). For example, a user may instruct computer 100 to check certain websites (possibly hosted by remote computer 209 or the like) for new or updated podcasts, traffic reports, weather reports, etc.

At step 505, a determination is made as to whether the user data 320 being monitored contains an action item. It will be appreciated that in an embodiment the interface program 300 is adapted to use the system clock 340 to, for example, review entries in a database and determine which currently-occurring items may require action. In an embodiment where computer 100 is checking remote websites or the like for media content, the determination may be to indicate if such content is available. If no action items are detected, the interface program 300 continues monitoring the user data 320 at step 500. If the user data 320 does contain an action item, interface program 300, at step 510, initiates a conversation with the user. Such an initiation may take place, for example, by the interface program 300 causing a software component to contact the user by way of a telephone 204 or cellular phone 208. Any of the hardware configurations discussed above in connection with FIGS. 2A-D are capable of carrying out such a function.

At step 515, a spoken prompt is issued to the user. For example, upon the user answering his or her cellular phone 208, the interface program 300 causes the text-to-speech engine 315 to generate a statement regarding the action item. It will be appreciated that other, non-action-item-related statements may also be spoken to the user at such time such as, for example, security checks, predetermined pleasantries, and the like. At step 520, the user response is received, and at step 525, the response is parsed and/or analyzed as discussed above in connection with FIGS. 4A-B. At step 530, a determination is made as to whether further action is required, based on the spoken utterance. If so, the method returns to step 515. If no further action is required, at optional step 535 the interface program 300 makes any adjustments that need to be made to user data 320 to complete the user's request such as, for example, causing the database interface 320 to save changes or settings, set an alarm, obtain and/or play media content and the like. The interface program 300 then returns to step 500 to continue monitoring the user data 320. It will be appreciated that the user may disconnect from the computer 100, or may remain connected to perform other tasks. In fact, the user may then, for example, issue instructions that are handled according to the method discussed above in connection with FIG. 4.

Thus, it will be appreciated that interface program 300 is capable of both initiating and receiving contact from a user with respect to user data 320 stored on or accessible to computer 100. It will also be appreciated that interface program 300, in some embodiments, runs without being seen by the user, as the user accesses computer 100 remotely. However, the user may have to configure or modify interface program 300 so as to have such program 300 operate according to the user's preferences. Accordingly, FIGS. 6A-F are screenshots illustrating an exemplary user interface 600 of such interface program 300 in accordance with an embodiment of the present invention. As noted above, one of skill in the art should be familiar with the programming and configuration of user interfaces for display on a display device of a computer 100, and therefore the details of such configurations are omitted herein for clarity.

Turning now to FIG. 6A, a user interface 600 of the aforementioned interface program 300 is illustrated. As can be seen in FIG. 6A, user interface 600 has several selectable tabs 602, each corresponding to various features grouped by function. As may be appreciated, any type of selection feature in place of or in addition to tabs 602 may be used while remaining consistent with an embodiment of the present invention. In FIG. 6A, it can also be seen that user interface 600 is presenting a “main menu.” Within such main menu of user interface 600 is an optional listing of phrases 604 that may be spoken by a user, along with a brief explanation of what each phrase 604 will accomplish. Such phrases are an example of the aforementioned grammars that may be discerned by the voice recognition 310 and natural language processing 325 components.

Referring now to FIG. 6B, another view of the user interface 600 is illustrated. In the view of FIG. 6B, an available speech profile 606 is displayed. As will be appreciated, and as was discussed above in connection with FIG. 3, the voice recognition software 315 (not shown in FIG. 6B for clarity) can, in one embodiment, be configured to respond to a variety of possible speech profiles. Such different profiles may correspond, for example, to different hardware or software configurations or different users as illustrated above in connection with FIG. 2.

Turning now to FIG. 6C, yet another view of the user interface 600 is illustrated. In FIG. 6C, a list of configuration options 608 is presented. As may be appreciated, such options 608 enable the interface program 300 to be customized for the user's preferences. For example, a location of the user (in terms of ZIP code or the like) may be requested to determine a time zone in which the user resides, and the like. As noted above, the interface program 300 may also be configured to interact with email and/or calendar or appointment software, such as Microsoft® Outlook®, Eudora, and so forth. Among other possible configuration options 608, and in one embodiment, are audio format settings 608a, connection settings 608b and the like. It will be appreciated that any number and type of configuration options 608 may be made available to a user by way of the user interface 600, and any such configuration options 608 are equally consistent with an embodiment of the present invention.

Turning now to FIG. 6D, another view of the user interface 600 is illustrated. In such a view, sheets 610 of user data 320 are shown to be available to the interface program 300. As noted above, the interface program 300 is capable of interfacing with other programs, data files, websites and the like. The view shown in FIG. 6D presents the available files and programs as “sheets” that may be selected or verbally requested by a user.

Referring now to FIG. 6E, yet another view of the user interface 600 is illustrated. In FIG. 6E, a listing of available search phrases 612 is listed, along with available search records 614. As noted above in connection with FIG. 3, the interface program 300 and/or the user data 320 may have a set of predetermined phrases, or grammars, that the computer 100 attempts to recognize by way of the voice recognition component 310. In such a manner, therefore, the reliability of the voice recognition component's 310 translation may be improved. Such grammars will be discussed below in greater detail in connection with FIG. 7.

Turning now to FIG. 6F, yet another view of the user interface 600 is illustrated. In the present view, a dialog 618—which shows the voice recognition software's 310 analysis of a user's spoken request—is shown. As may be appreciated, a user will, in one embodiment of the present invention, not see such dialog 618, if the user is located remotely from the computer 100. However, such a dialog 618 may be presented by such user interface 600 for diagnostic, entertainment or other purposes.

Turning now to FIG. 7A, a sheet 700 of user data 320 is illustrated. As can be seen in FIG. 7A, the exemplary sheet 700 illustrated is a spreadsheet, although as may be appreciated the sheet 700 may be any type of information data type that is accessible to or stored on computer 100. In the sheet 700, a listing of grammars 712 is illustrated, as well as search records 714 which, in FIG. 7A, are individual stock records. In addition, it can be seen in FIG. 7A that the spreadsheet 700 comprises several sheets 716 of data, any of which are accessible to an embodiment of the present invention. Sheets 716 indicate that the spreadsheet 700 contains multiple levels of data, any of which may be accessed by a user. As noted above in connection with FIG. 3, any type of user data 320 that is organized in any fashion and stored in any type of file is equally consistent with an embodiment of the present invention.

However, in one embodiment, the audio input to and output from the computer 100 is located in the first and second rows, respectively, of sheet 716 in each column. In such an embodiment, the computer 100 may be programmed to detect the entire question, or just key words or the like. The computer 100 thus responds with the predetermined answer, as shown in the second row. It will be appreciated that in one embodiment the answer restates the question in some form so as to avoid confusing the user, and to let the user know that the computer 100 has interpreted the user's question accurately.

It will be appreciated that a user may program such spreadsheets 700 with customized information, so the user will have a spreadsheet 700 that contains whatever information the user desires, in any desired format. In addition, the use of spreadsheets permits the user to, for example, download such spreadsheets 700 from a network 120, the Internet or the like. It will also be appreciated that the full functionality of such a spreadsheet 700 program (including web queries, smart tags and the like) may be used to provide the user with a flexible means for storing and accessing data that is independent of both the interface program 300 and the remote communications device being used. As will be appreciated, the exemplary stock quote spreadsheet 700 of FIG. 7 uses functions that automatically update the stock prices by way of the network 120 or the like, thereby keeping time-sensitive data current.

It will be appreciated that such phrases 712, in one embodiment, contain multiple possible grammars for requesting the same information. In such a manner, the user does not have to remember the exact syntax for the desired query, which is of particular in embodiments where the user is located remotely from the computer 100. Therefore, a request having a slight variation in the spoken syntax can still be recognized by the computer 100.

As an example, an inflexible grammar for requesting the current price of a particular stock may only return a response if the spoken utterance is exactly: “what is the current price of [record]?” In contrast, a flexible grammar can contain a plurality of grammatically-equivalent phrases that a user might use when speaking to the computer 100 such as, for example, “what is,” “what's,” “what was,” the “last price,” “current price,” “price,” of/for [record] and the like. Accordingly, a user who says, “what's the price for [record]?” will get the same response as a user who says, “what was the last price of [record]?” It will be appreciated that in one embodiment such flexibility is provided by way of logical symbols and the like, but any such method of providing a flexible grammar is equally consistent with an embodiment of the present invention. As can be seen in the second row of the spreadsheet 700, an answer to the question posed above would be “the last price for [record] was [price].”

In one embodiment, the interface program 300, by way of the data file interface 335, interfaces with a spreadsheet, such as a Microsoft® Excel spreadsheet, in such a manner that a user can readily access data in a logical, and yet personalized manner. The data file interface 335 looks for input grammar in, for example, row 1 of sheet 2, output grammar in row 2 of sheet 2 and record labels in column 1 of sheet 2. When a user asks the interface program 300 to look-up a file, the data file interface 335 opens the spreadsheet and goes to sheet 2. The interface program 300 generates all of the possible input grammars (i.e., every question in row 1, in every form with respect to flexible grammars) is combined with every record. For example, in the above example the flexible grammar is “what is,” “what's,” “what was,” the “last price,” “current price,” “price,” of/for [record]. Such a grammar would generate three separate grammars for “what is,” “what's” and “what was.” This would be multiplied by three grammars for “last price,” “current price” and “price,” and by two more grammars for “of” or “for,” and then would be multiplied again for the number of stocks (records) in the sheet.

The interface program, in such an embodiment, is then programmed to respond with the text-to-speech output grammar corresponding to the identified input grammar. The output grammar is generally a combination of the “output grammar” found in row 2, with the record label that is part of the input grammar, and the data “element” that is found in the cell that correlates with the column of the input grammar and the input record. The interface program 300 then sends the text-to-speech output to the selected output communications device. This format allows the user to readily program input and output grammars that are useful and personal.

It will also be appreciated that in some embodiments or contexts, a flexible grammar may not be appropriate, and in still other embodiments the grammar of the computer's 100 spoken text may be flexible as well. In such a manner, the computer 100 has a more “natural” feel for the user, as the computer 100 varies its text in a more realistic way. Such variance may be accomplished, for example, by way of a random selection of one of a plurality of equivalent grammars, or according to the particular user, time of day, and/or the like.

It will also be appreciated that a spreadsheet 700 may contain macros for performing certain tasks. For example, an entry in a spreadsheet may be configured to respond to the command “call Joe Smith” by looking up a phone number associated with a “Joe Smith” entry in the same or different spreadsheet, or even in a separate application such as Microsoft® Outlook® or another an email program. The interface program 300 may then access a component for dialing a phone number, and the phone number would then be dialed and the call connected to the user. Any such functionality can be used in accordance with an embodiment of the present invention. For example, in the spreadsheet 700 of FIG. 7A, the stock prices and other such information is acquired from a website by way of an active web link for each stock's price. It will also be appreciated that other type of files such as, for example, tab delimited text files, database files, word processing files and the like could all provide an open architecture in which the user can create numerous individualized data sources.

Referring now to FIG. 7B, an alternate view of the spreadsheet 700 is illustrated. In the present view, a series of search records 714 are again illustrated. In FIG. 7B, the search records 714 illustrated are for various stock indices although, and as noted above, such records 714 may comprise any type of information. In the present example of stock indices, as well as the stock example of FIG. 7A, above, it will be appreciated that the data associated with such record 714 may be updated by way of a network 120 such as, for example, the Internet. As was the case in FIG. 7A, sheet 716 indicates that the spreadsheet 700 contains multiple levels of data that may be accessed by a user. As may be appreciated, the sheet 716 of FIG. 7B is contained within the spreadsheet 700 of FIG. 7A, although any arrangement of sheets 716 and spreadsheets is equally consistent with an embodiment of the present invention.

Thus, a method and system for operatively connecting a computer to a remote communications device by way of verbal commands has been provided. While the present invention has been described in connection with the exemplary embodiments of the various figures, it is to be understood that other similar embodiments may be used or modifications and additions may be made to the described embodiment for performing the same function of the present invention without deviating therefrom. For example, one skilled in the art will recognize that the present invention as described in the present application may apply to any configuration of communications devices or software applications. Therefore, the present invention should not be limited to any single embodiment, but rather should be construed in breadth and scope in accordance with the appended claims.

What is claimed:

1. A computer readable medium having computer executable instructions for performing:
accessing, using a personal computer, media content;
extracting information from the media content;
generating a signal representative of the extracted information; and
transmitting the signal to a remote communications device by way of a communications channel.

2. The computer readable medium of claim 1, wherein the communications channel between the personal computer and the remote communications device is initiated by a user of the remote communications device or an interface program running on the personal computer.

3. The computer readable medium of claim 1, further comprising:
receiving, using the personal computer, a request for the media content in the form of an audio signal; and
interpreting the audio signal to identify the requested media content.

4. The computer readable medium of claim 3, wherein the audio signal is at least one of the following: a spoken utterance and a dual tone multi frequency (DTMF) signal.

5. The computer readable medium of claim 1, wherein the communications channel comprises at least one of the following: a public switched telephone network (PSTN), a cellular network, a voice over internet protocol (VoIP) network, a radio network, a local area network (LAN) and a wide area network (WAN).

6. The computer readable medium of claim 1, wherein the signal is transmitted to the remote communications device using at least one of the following devices: a network interface card, a modem, a telephony interface device, a cellular telephone comprising a cable interconnection with the personal computer, a cellular personal computing telephony device, a cordless telephone, a telephone gateway device, and a corded telephone comprising a cable interconnection with the personal computer.

7. The computer readable medium of claim 1, wherein the remote communications device comprises at least one of the following: a cellular telephone, a cordless telephone, a corded telephone, a speakerphone, a second computer having telephony software, a second computer having a Voice over Internet Protocol (VoIP) connection, and a second computer having instant messaging software.

8. The computer readable medium of claim 1, wherein the media content comprises audio or video information.

9. The computer readable medium of claim 1, wherein the media content is stored in a remote computer.

10. The computer readable medium of claim 9, wherein the media content is accessed on the remote computer using a network link to the media content.

11. The computer readable medium of claim 10, further comprising downloading the media content from the remote computer to the personal computer.

12. The computer readable medium of claim 10, further comprising streaming the media content to the personal computer from the remote computer.

13. The computer readable medium of claim 1, further comprising manipulating the signal upon receiving one of the following commands from the remote communications device: pause, resume play, fast forward, rewind, skip forward, skip back, or stop.

14. A method for accessing media content on a remote communications device using a personal computer, comprising:
receiving a media content request from the remote communications device by way of a communications channel;
interpreting the media content request to identify the requested media content;
accessing the requested media content;
extracting information from the requested media content; and
generating a signal representative of the extracted information.

15. The method of claim 14, further comprising transmitting the signal to the remote communications device by way of the communications channel.

16. The method of claim 14, wherein the media content request is received as an audio signal.

17. The method of claim 14, wherein the requested media content is stored in a remote computer.

18. The method of claim 17, wherein the requested media content is accessed on the remote computer using a network link to the requested media content.

19. The method of claim 17, further comprising manipulating the signal upon receiving one of the following commands from the remote communications device: pause, resume play, fast forward, rewind, skip forward, skip back, or stop.

20. A personal computer, comprising;
a communication port for enabling communication with a communications channel; and
a processor adapted to execute:
an input recognition software component for interpreting a media content request received from a remote communications device by way of the communication port;
a file interface software component for extracting information from the requested media content;
an output software component for generating a signal representative of the extracted information;
a communication software component for transmitting the signal to the remote communications device by way of the communication port; and
an interface program for receiving the media content request, wherein the interface program causes the input recognition component to interpret the media content request, causes the file interface component to extract the information from the media content, and causes the communications component to transmit the signal.
